(19) United States
(12) Patent Application Publication
(10) Pub. No.: US 2013/0236724 A1
(43) Pub. Date: Sep. 12, 2013

(54) DOUBLE-SIDED ADHESIVE TAPE

(71) Applicant: NITTO DENKO CORPORATION, Osaka (JP)

(72) Inventors: Shuuhei YAMAMOTO, Osaka (JP); Kazuyuki YAGURA, Osaka (JP)

(73) Assignee: NITTO DENKO CORPORATION, Osaka (JP)

(21) Appl. No.: 13/785,074

(22) Filed: Mar. 5, 2013

(30) Foreign Application Priority Data
Mar. 7, 2012 (JP) 2012-050879
Jan. 17, 2013 (JP) 2013-006542

(51) Int. Cl. C09J 7/02

(52) U.S. Cl. CPC C09J 7/0203; C09J 7/0207
USPC 428/349

(57) ABSTRACT

A double-sided adhesive tape for fixing a polishing member includes: a substrate; a thermal adhesive layer that is provided on one surface of the substrate and is formed of a thermal adhesive containing 40 to 100% by mass of a thermoplastic elastomer based on the total mass of the thermal adhesive; and a pressure-sensitive adhesive layer provided on the other surface of the substrate. When being pressure-bonded to a polyethylene terephthalate film with a pressure of 5.19 kgf and at 50° C. for 30 seconds, the thermal adhesive layer has a 180°-peeling pressure-sensitive adhesive force to the polyethylene terephthalate film of 15 N/20 mm or more at a tensile speed of 50 mm/min.

### BACKGROUND OF THE INVENTION

1. Field of the Invention

The present invention relates to a double-sided adhesive tape, and in particular, to a double-sided adhesive tape for fixing a polishing member.

(2) Description of the Related Art

Until now, polishing apparatuses for polishing the surfaces of glass for liquid crystal, silicon wafers, and hard disk substrates, are known. In a polishing apparatus, a double-sided adhesive tape is used to fix a polishing member, such as a polishing pad, abrasive cloth, or the like, to the surface plate of the polishing apparatus (see, for example, Patent Document 1).

### PATENT DOCUMENT

[Patent Document 1] Japanese Patent Application Publication No. 2007-203400

As a double-sided adhesive tape for fixing a polishing member, a double-sided adhesive tape of a thermal adhesion type, by which a polishing member and a surface plate are adhered together with thermal pressure-bonding, is desirable in order to meet a demand for firmly fixing the above two objects and in order to make position adjustment of a polishing member to be easy.

However, when a polishing member, a double-sided adhesive tape, and a surface plate are thermally pressure-bonded together, there is the fear that a warp or undulation may occur in the polishing member after the thermal adhesion due to the differences among the thermal shrinkage ratios of the three objects, thereby causing the fear that polishing accuracy may be decreased. The size of each of glass for liquid crystal and a semiconductor substrate is being increased particularly in recent years, for example, with liquid crystal displays growing in size. In addition, there is a demand that many members to be polished should be polished at one time for productivity improvement. In order to polish a member to be polished whose size is increased or to polish many members to be polished at one time, the size of a polishing member used in a polishing apparatus is also being increased. Accordingly, a double-sided pressure-sensitive adhesive tape whose size is increased is needed to fix a polishing member whose size is increased to a surface plate. When the size of a double-sided adhesive tape is increased, a warp or undulation in a polishing member, occurring due to being heated during bonding, further becomes remarkable, thereby causing polishing accuracy to be further decreased.

In addition, for example, when a double-sided adhesive tape, the release liner (separator) on one side of which has been peeled off, is thermally adhered to a polishing member to preserve the polishing member in a state where the double-sided adhesive tape is being adhered thereto, a warp occurs in the remaining release liner due to being heated, thereby causing the fear that the release liner may be peeled off.

As a method of preventing a warp or undulation in a polishing member or peeling of a remaining release liner, occurring due to being heated, it can be considered that a double-sided adhesive tape is thermally adhered to a polishing member and a surface plate at a lower temperature. In conventional double-sided pressure-sensitive adhesive tapes, however, there are sometimes the cases where sufficient adhesive strength cannot be obtained in thermal adhesion at a low temperature. Also, with double-sided adhesive tapes growing in size, there are sometimes the cases where a double-sided adhesive tape of a pressure-sensitive type is difficult to be handled and the position adjustment between the double-sided adhesive tape and a polishing member is difficult.

### SUMMARY OF THE INVENTION

The present invention has been made in view of these situations, and a purpose of the invention is to provide a double-sided adhesive tape for fixing a polishing member in which large adhesive strength can be obtained in thermal adhesion at a lower temperature.

An embodiment of the present invention is a double-sided adhesive tape. The double-sided adhesive tape is used for fixing a polishing member, and comprises: a substrate; a thermal adhesive layer that is provided on one surface of the substrate and is formed of a thermal adhesive containing 40 to 100% by mass of a thermoplastic elastomer based on the total mass of the thermal adhesive; and a pressure-sensitive adhesive layer provided on the other surface of the substrate, in which, when being pressure-bonded to a polyethylene terephthalate film with a pressure of 5.19 kgf and at 50° C. for 30 seconds, the thermal adhesive layer has a 180°-peeling pressure-sensitive adhesive force to the polyethylene terephthalate film of 15 N/20 mm or more at a tensile speed of 50 mm/min.

In a double-sided adhesive tape according to the aforementioned embodiment, the pressure-sensitive adhesive layer may contain one or more pressure-sensitive adhesives selected from the group consisting of a rubber pressure-sensitive adhesive and an acrylic pressure-sensitive adhesive. In addition, the melting temperature of the thermal adhesive layer may be 50 to 110° C. In addition, the thermal adhesive layer may contain a styrene-butadiene elastomer.

In addition, the thermal adhesive layer may contain a tackifier. In addition, the thermal adhesive layer may contain a styrene-butadiene elastomer and a tackifier, and the content of the tackifier may be 50 to 150 parts by mass based on 100 parts by mass of the styrene-butadiene elastomer. In addition, the glass transition point of the tackifier may be 60° C. or lower.

A pressure-sensitive adhesive tape in which the respective components described above are appropriately combined can be encompassed within the scope of the invention for which protection is sought by this application.

### BRIEF DESCRIPTION OF THE DRAWING

Embodiments will now be described, by way of example only, with reference to the accompanying drawing which is meant to be exemplary, not limiting, in which:

FIG. 1 is a schematic sectional view illustrating the structure of a double-sided adhesive tape according to an embodiment.

### DETAILED DESCRIPTION OF THE INVENTION

The invention will now be described by reference to the preferred embodiments. This does not intend to limit the scope of the present invention, but to exemplify the invention.

Hereinafter, the present invention will be described with reference to the drawing based on the preferred embodiments of the invention. The preferred embodiments do not intend to limit the scope of the invention but exemplify the invention. All of the features and the combinations thereof described in the embodiments are not necessarily essential to the invention.

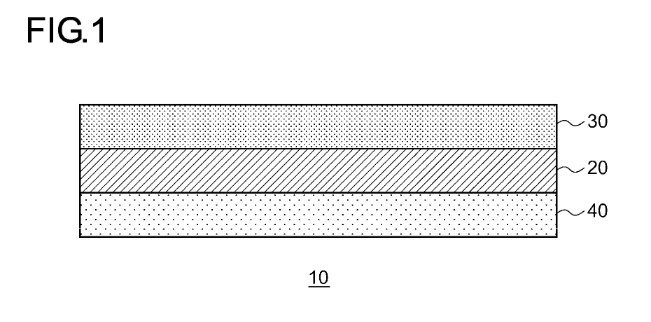

FIG. 1 is a schematic sectional view illustrating the structure of a double-sided adhesive tape according to an embodiment. A double-sided adhesive tape 10 according to the present embodiment comprises a substrate 20, a thermal adhesive layer 30, and a pressure-sensitive adhesive layer 40. The double-sided adhesive tape 10 is used for fixing a polishing member, such as abrasive cloth, polishing pad, or the like. Specifically, the double-sided adhesive tape 10 is used for fixing a polishing member to the surface plate of a polishing apparatus by which a polishing member to be polished, such as glass for liquid crystal, a silicon wafer, a hard disk substrate, or the like, is polished. The double-sided adhesive tape 10 can also be used when a polishing member to be polished is fixed to the surface plate of a polishing apparatus directly or through a fixing pad, etc. Hereinafter, each portion forming the double-sided adhesive tape 10 will be described in detail.

### (Substrate)

The substrate 20 can be formed of a material that is conventionally used as a substrate, such as a plastic film, paper, metallic foil, woven cloth, non-woven cloth, or the like; however, a plastic film is preferred from the viewpoints of strength and thickness accuracy. As the plastic film, polyester films, such as a polyethylene terephthalate (PET) film and a polybutylene terephthalate film, and polyolefin films, such as a polyethylene film and a polypropylene film, can be used. The thickness of the substrate is, for example, 10 μm to 300 μm, and preferably 25 μm to 100 μm.

### (Thermal Adhesive Layer)

The thermal adhesive layer 30 is: provided on one surface of the substrate 20; formed of a thermal adhesive; and used for adhesion of a polishing member. The thermal adhesive exerts an adhesive force when being heated, and examples thereof include a type that adheres objects by being thermally melted and then by being cooled and solidified (hot melt type adhesive) and a type that adheres objects by being thermally cured (thermosetting type adhesive); however, a hot melt type adhesive is preferred. The thickness of the thermal adhesive layer 30 is, for example, 20 to 100 μm.

As a hot melt type adhesive forming the thermal adhesive layer 30, an adhesive, containing 40 to 100% by mass of a thermoplastic elastomer based on the total mass of the thermal adhesive, is preferred. An example of the thermoplastic elastomer includes, for example, a copolymer (in particular, a block copolymer) of a mono-vinyl substituted aromatic compound and a conjugated diene compound. Examples of the mono-vinyl substituted aromatic compound include, for example, styrene, α-methylstyrene, vinyl toluene, and vinylxylene, etc. Examples of the conjugated diene compound include, for example, 1,3-butadiene and isoprene, etc. Specific examples of the thermoplastic elastomer preferably include both a block copolymer of styrene and a conjugated diene, such as butadiene, isoprene, or the like, and a hydrogenated block copolymer thereof, and more preferably include adhesives each containing a styrene-butadiene elastomer. The content of the thermoplastic elastomer in the thermal adhesive forming the thermal adhesive layer 30 is preferably 40 to 100% by mass, more preferably 50 to 95% by mass, and still more preferably 60 to 90% by mass. Herein, the thermal adhesive layer 30 may contain a tackifier.

The aforementioned styrene-butadiene elastomer is preferably exemplified by, for example, a styrene-butadiene block copolymer, a block copolymer of styrene and butadiene that is a conjugated diene. Examples of the styrene-butadiene block copolymer include: a styrene-based AB type diblock copolymer; a styrene-based ABA-type triblock copolymer; a styrene-based ABAB-type tetra-block copolymer; a styrene-based ABABA-type penta-block copolymer; and a styrene-based multiblock copolymer having six or more of AB repeating units, etc. Among them, a styrene-butadiene-styrene block copolymer (SBS), an ABA-type block copolymer in which blocks of a styrene polymer and blocks of a butadiene polymer are alternately located, or a hydrogenated block copolymer thereof, can be preferably used.

The content of a styrene polymer in the styrene-butadiene block copolymer is usually 10 to 40% by mass, and preferably 13 to 35% by mass. The weight average molecular weight of the whole copolymer is preferably 50,000 to 700,000, and more preferably 100,000 to 400,000. The weight average molecular weight is a value measured by gel permeation chromatography. Specifically, a polystyrene equivalent value, measured by gel permeation chromatography under the conditions in which tetrahydrofuran (THF) is used as a mobile phase and a flow rate is 1.0 mL/min, is determined to be a weight average molecular weight.

Examples of the tackifier contained in the thermal adhesive layer 30 include tackifying resins, such as, for example, a rosin resin, terpene resin, petroleum resin, hydrogenated petroleum resin, aliphatic hydrocarbon resin, and aromatic hydrocarbon resin. As an example, it is preferable to use a styrene tackifying resin as one of essential components. As another example, it is preferable to use an aliphatic hydrocarbon resin as one of essential components, without containing a styrene tackifying resin. In this case, the tackiness before thermal adhesion (adhesive force immediately after pressure-bonding) can be improved, and accordingly, it can be suppressed that pop-off or slippage of a tape may occur during the period from when the tape is tentatively pressure-bonded to a polishing member to when the tape is firmly pressure-bonded by thermal adhesion. In addition, it is preferable that the tackifier has a glass transition point of 60° C. or lower. By containing a tackifier having a glass transition point of 60° C. or lower in the thermal adhesive layer 30, the adhesive strength, obtained in thermal adhesion at a low temperature, can be enhanced.

The content of the tackifier is preferably 10 to 150 parts by mass, more preferably 30 to 150 parts by mass, and still more preferably 50 to 150 parts by mass, based on 100 parts by mass of the styrene-butadiene elastomer. By making the contents of the styrene-butadiene elastomer and the tackifier to be within such a range, the tackiness at room temperature can be reduced and position adjusting work for fixing a polishing member can be made easy. On the other hand, it is also possible to suppress pop-off or slippage of a tape, which may occur during position adjusting work for fixing a polishing member, by enhancing the tackiness at room temperature. When the content of the tackifier is within the aforementioned range, as stated above, appropriate tackiness can be provided and a polishing member can be easily adhered by heating the thermal adhesive layer after the position adjustment.

When being pressure-bonded to a polyethylene terephthalate film with a pressure of 5.19 kgf and at 50° C. for 30 seconds, the thermal adhesive layer 30 has a 180°-peeling pressure-sensitive adhesive force to the polyethylene terephthalate film of 15 N/20 mm or more at a tensile speed of 50 mm/min, and preferably 20 N/20 mm or more. The 180°-peeling pressure-sensitive adhesive force is preferably 30 N/20 mm or less. By making the 180°-peeling pressure-sensitive adhesive force of the thermal adhesive layer 30 to be 15 N/20 mm or more, sufficient adhesive strength can be obtained even in thermal adhesion at a low temperature of approximately 50° C., thereby allowing a polishing member and a surface plate to be firmly fixed together. Also, by making the 180°-peeling pressure-sensitive adhesive force thereof to be 30 N/20 mm or less, it can be suppressed that work for changing polishing members, etc., may become difficult.

The melting temperature (MT) of the thermal adhesive layer 30 is preferably 50 to 110° C., and more preferably 50° C. MT<75° C. By making MT to be 50° C.≦MT≦110° C., the adhesive strength to a polishing member in thermal adhesion at a low temperature can be enhanced. Herein, the “melting temperature” means a temperature at which the thermal adhesive layer 30 melts and tackiness starts to develop.

Other than the aforementioned components, additives, such as a softener, plasticizer, filler, antioxidant (anti-aging agent), and colorant, may be contained in the thermal adhesive layer 30, if necessary.

### (Pressure-Sensitive Adhesive Layer)

The pressure-sensitive adhesive layer 40 is one provided on the other surface of the substrate 20, and is used for adhesion to the surface plate of a polishing apparatus. The composition of the pressure-sensitive adhesive layer 40 is not particularly limited, but various pressure-sensitive adhesive layers that are conventionally and publicly known can be used. Specific examples of the pressure-sensitive adhesive layer 40 include a rubber pressure-sensitive adhesive layer and an acrylic pressure-sensitive adhesive layer, etc.

### (Rubber Pressure-Sensitive Adhesive Layer)

As the rubber pressure-sensitive adhesive layer, a pressure-sensitive adhesive layer, formed of a rubber pressure-sensitive adhesive containing at least one of natural rubber and synthetic rubber in the total amount of the two of 50 to 100% by mass based on the total mass of the rubber pressure-sensitive adhesive, is preferably used. In a rubber pressure-sensitive adhesive that forms the rubber pressure-sensitive adhesive layer, the total content of the natural rubber and synthetic rubber is preferably 50 to 100% by mass, more preferably 55 to 90% by mass, and still more preferably 60 to 80% by mass.

The natural rubber to be used in the rubber pressure-sensitive adhesive layer is not particularly limited, but is used after being mixed by a mixing roll and then adjusted such that a Mooney viscosity becomes, for example, approximately 10 to 100. Also, the synthetic rubber to be used in the rubber pressure-sensitive adhesive layer is not particularly limited, but, for example, a styrene-isoprene-styrene block copolymer (SIS), styrene-butadiene-styrene block copolymer (SBS), hydrogenated block copolymers of the above styrene-based block copolymers, styrene-butadiene rubber (SBR), polyisoprene rubber (IR), polyisobutylene (PIB), and butyl rubber (IIR), etc., can be used.

The rubber pressure-sensitive adhesive layer may contain a tackifier, in addition to the aforementioned natural rubber and/or the synthetic rubber. Examples of the tackifier include a rosin resin, terpene resin, petroleum resin, etc. The use amount of the tackifier is, for example, 20 to 150 parts by mass based on 100 parts by mass of the natural rubber and/or the synthetic rubber.

Other than the aforementioned components, additives, such as a softener, plasticizer, filler, antioxidant, and colorant, may be contained in the rubber pressure-sensitive adhesive layer, if necessary.

### (Acrylic Pressure-Sensitive Adhesive Layer)

The acrylic pressure-sensitive adhesive layer is not particularly limited, but a pressure-sensitive adhesive layer, formed of a pressure-sensitive adhesive that contains, as a base polymer, an acrylic polymer obtained by polymerizing a monomer composition containing a (meth)acrylic acid alkyl ester having a C₂₋₁₄ alkyl group, can be preferably used.

The C₂₋₁₄ alkyl group of the (meth) acrylic acid alkyl ester may be either a linear group or a branched group. Examples of the (meth)acrylic acid alkyl ester having a C₂₋₁₄ alkyl group include, for example, ethyl(meth)acrylate, n-propyl(meth)acrylate, n-butyl(meth)acrylate, t-butyl(meth)acrylate, 2-ethylhexyl(meth)acrylate, isooctyl(meth)acrylate, and isononyl(meth)acrylate, etc. Among them, n-butyl acrylate and 2-ethylhexyl acrylate are preferably used from the viewpoints of performance, cost, and versatility.

The acrylic polymer may contain a carboxyl group-containing unsaturated monomer as a monomer structural unit.

Examples of the carboxyl group-containing unsaturated monomer include, for example, (meth) acrylic acid, itaconic acid, fumaric acid, and maleic acid. An acrylic acid is preferably used as the carboxyl group-containing unsaturated monomer from the viewpoints of performance, cost, and versatility.

The (meth) acrylic acid alkyl having a C₂₋₁₄ alkyl group is used usually and preferably in an amount of approximately 50 to 99 parts by mass, more preferably in an amount of approximately 75 to 99 parts by mass, and still more preferably in an amount of approximately 90 to 99 parts by mass.

In addition to the (meth)acrylic acid alkyl ester having a C₂₋₁₄ alkyl group and the carboxyl group-containing unsaturated monomer, any other monomer can be polymerized in the acrylic polymer. Examples of the any other monomer include, for example: hydroxyl group-containing monomers, such as 2-hydroxyethyl(meth)acrylate, 2-hydroxypropyl(meth)acrylate, and hydroxyhexyl(meth)acrylate; nitrogen-containing (meth)acrylates, such as (meth)acrylamide and acryloyl morpholine; and polar monomers, such as methyl(meth)acrylate, (meth)acrylic acid alkyl whose alkyl group has 15 or more of carbon atoms, and vinyl acetate. These polar monomers are effective in enhancing the cohesive force of a pressure-sensitive adhesive. Also, monomers that can provide a polymer having a high glass transition point, such as (meth)acrylonitrile, styrene, vinylidene chloride, and vinyl propionate, can be used. The any other monomer is used usually in an amount of 0 to 50 parts by mass based on 100 parts by mass of (meth) acrylic acid alkyl ester having a C₂₋₁₄ alkyl group.

The weight average molecular weight (GPC) of the acrylic polymer is not particularly limited, but it is preferable that the GPC is approximately 300,000 to 2,500,000. The acrylic polymers can be manufactured by various publicly known methods; and a radical polymerization method, such as, for example, a bulk polymerization method, solution polymerization method, suspension polymerization method, emulsion polymerization method, or the like, can be appropriately selected.

The acrylic pressure-sensitive adhesive layer preferably contains a tackifying resin, and more preferably contains a tackifying resin including a a natural product as a raw material. Examples of the natural product used as a raw material include both terpenes represented by pinene and limonene and rosin, which naturally exist. These tackifying resins only have to use natural products as a raw material, and herein the natural products may include one subjected to a chemical reaction. Examples of the chemical reaction include: one in which a natural product to be used as a raw material is converted into a derivative thereof by performing a disproportionation reaction, a hydrogenation reaction, or a dimerization reaction on the natural product; one in which a natural product is changed to a modified substance by reacting an unsaturated compound, such as maleic acid, fumaric acid, (meth)acrylic acid, or the like, with the natural product; one in which a natural product is changed to a modified substance by reacting a phenol, or the like, with the natural product; and one in which a natural product or a derivative thereof is converted into an ester compound by reacting it with a polyhydric alcohol, etc.

Rosin is preferred as the aforementioned natural product. The rosin can be converted into derivatives thereof, such as disproportionated rosin, hydrogenated rosin, polymerized rosin, maleated rosin, and fumarated rosin. A rosin-phenolic resin and rosin ester are preferred as the tackifying resin. Examples of the rosin-phenolic resin include: a resin obtained by adding a phenol to the aforementioned rosin resin (natural rosin, rosin derivative); a so-called rosin modified phenolic resin obtained by reacting a resol-type phenolic resin and a rosin resin together. The rosin-phenolic resin can be used as a metal salt of the rosin-phenolic resin. An example of the rosin ester includes an ester compound obtained by reacting the rosin resin and a polyhydric alcohol together. Herein, the rosin-phenolic resin can be converted into an esterified compound.

Examples of the tackifying resin containing a natural product as a raw material, which are commercially available, include: YS Polystar T145 (made by YASUHARA CHEMICAL CO., LTD.) as a terpene phenolic resin; TAMANOL 803 (made by Arakawa Chemical Industries, Ltd.), TAMANOL 803L (made by Arakawa Chemical Industries, Ltd.), and SUMILITE RESIN PR-12603N (made by Sumitomo Bakelite Co., Ltd.), etc., as a rosin-phenolic resin. Examples of the rosin ester include: KT-2 (made by HARIMA CHEMICALS, Inc.), PENSEL D125 (made by Arakawa Chemical Industries, Ltd.), Pentalyn CJ (made by Rika Fine-Tech Inc.), and RIKATAC PCJ (made by HARIMA CHEMICALS, Inc.), as polymerized rosin pentaerythritol ester; Super Ester A125 (made by Arakawa Chemical Industries, Ltd.), Super Ester A100(made by Arakawa Chemical Industries, Ltd.), as disproportionated maleic acid modified rosin ester; and Staybelite Ester 10 (made by Rika Fine-Tech Inc.), Estergum H (made by Arakawa Chemical Industries, Ltd.), and HERCOLYN D (made by Hercules Japan) that is hydrogenated rosin methyl ester, etc., as hydrogenated rosin glycerin ester.

As the tackifying resin containing a natural product as a raw material, it is preferable to use at least four types of the resins whose molecular structures are different from each other. In addition, it is preferable to select the tackifying resins such that the cloudy points of which to isoparaffin hydrocarbon are different from each other and the differences among the cloudy points become 20° C. or more. In addition, it is preferable to select the tackifying resins such that at least two types of the tackifying resin each having a softening point of 100° C. or higher are included and at least two types thereof each having a softening point of lower than 100° C. are included.

The blending amount (BA) of each tackifying resin is 5 parts by mass≦BA≦20 parts by mss based on 100 parts by mass of the acrylic polymer. The BA is preferably 5 parts by mass≦BA≦15 parts by mass. Herein, the respective blending amounts of the tackifying resins may or may not be the same as each other.

The total blending amount (TBA) of the tackifying resins is 20 parts by mass≦TBA≦80 parts by mass based on 100 parts by mass of the acrylic polymer. The TBA is preferably 30 parts by mass≦TBA≦60 parts by mass, and more preferably 30 parts by mass≦TBA≦50 parts by mass. When the TBA is 20 parts by mass or more, an effect of the tackifying resins can be sufficiently exerted, thereby allowing pressure-sensitive adhesiveness to be further improved. Further, when the TBA is 80 parts by mass or less, cohesive force and heat resistance can be further improved.

The acrylic pressure-sensitive adhesive layer can contain a cross-linking agent, in addition to the acrylic polymer and the tackifying resin. Examples of the cross-linking agent include, for example, an epoxy cross-linking agent, isocyanate cross-linking agent, and aziridine cross-linking agent, etc. It is preferable to use an isocyanate cross-linking agent in order to achieve both removability and pressure-sensitive adhesiveness at a higher level. Although the addition amount of a cross-linking agent varies in accordance with the application of the tape and the type of the cross-linking agent, it is 5 parts by mass or less, and preferably within a range of approximately 0.01 to 5 parts by mass, based on 100 parts by mass of the acrylic polymer.

Additives, such as a pigment, dye, flame retardant, and heat stabilizer, may be appropriately added to the acrylic pressure-sensitive adhesive layer in an amount by which the adhesive residue preventing property and the pressure-sensitive adhesive property are not deteriorated.

### (Shape of Double-Sided Adhesive Tape)

The double-sided adhesive tape 10 may be provided with release liners (separators) on both major surfaces thereof, i.e., on the major surface of each of the thermal adhesive layer 30 and the pressure-sensitive adhesive layer 40, in a state before the tape 10 is used, i.e., before the tape 10 is adhered to a polishing member or a surface plate. Both the major surfaces of the double-sided adhesive tape 10 may be protected by the two release liners, or both the major surfaces thereof may be protected by one release liner whose both the surfaces are release surfaces in a form in which the tape 10 is wound into a roll shape. The release liner is used for protecting the thermal adhesive layer 30 and the pressure-sensitive adhesive layer 40, and is peeled off when the double-sided adhesive tape 10 is attached to an adherend (polishing member, surface plate). Herein, the release liner is not necessarily provided. As the release liner, for example, a plastic film and paper, on the surfaces of which a remover, such as a silicon remover, a long-chain alkyl remover, or the like, has been coated, can be used.

The width of the double-sided adhesive tape 10 according to the present embodiment is 1300 to 3000 mm, preferably 1500 to 2800 mm, and more preferably 2100 to 2500 mm.

It is preferable to manufacture the double-sided adhesive tape 10 according to the present embodiment by providing the substrate 20 or a release liner having a large width (preferably 2100 to 3000 mm, and more preferably 2500 to 3000 mm) and then by coating both a thermal adhesive forming the thermal adhesive layer 30 and a pressure-sensitive adhesive forming the pressure-sensitive adhesive layer 40 with a pressure-sensitive adhesive composition coater having a large width corresponding to the width of the substrate 20 or the release liner. Examples of the pressure-sensitive adhesive composition coater having a large width include coaters having a roll width of 2100 to 3000 mm, such as, for example, a gravure coater, fountain die coater, lip coater, and comma coater. By respectively and collectively coating the thermal adhesive layer 30 and the pressure-sensitive adhesive layer 40 each having a large width with the use of such a pressure-sensitive adhesive composition coater having a large width, a risk of occurrence of an appearance defect can be further reduced.

In the double-sided adhesive tape 10 according to the present embodiment, the thermal adhesive layer 30 is made of a thermal adhesive whose major component is a thermoplastic elastomer, as stated above. And, when being pressure-bonded to a polyethylene terephthalate film with a pressure of 5.19 kgf and at 50° C. for 30 seconds, the thermal adhesive layer 30 has a 180°-peeling pressure-sensitive adhesive force to the film of 15 N/20 mm or more at a tensile speed of 50 mm/min. Accordingly, large adhesive strength can be obtained in thermal adhesion at a lower temperature in comparison with a conventional double-sided adhesive tape for fixing a polishing member. Thereby, thermal adhesion performed at a high temperature, which is intended to obtain sufficient adhesive strength, can be avoided, and hence it can be suppressed that a warp or undulation, occurring due to the differences among the thermal shrinkage ratios of a polishing member, the double-sided adhesive tape 10, and a surface plate, may occur. Therefore, the double-sided adhesive tape 10 according to the embodiment can be preferably adopted for fixing a polishing member whose size is particularly increased (large area, large width).

### EXAMPLES

Hereinafter, the present invention will be described in detail based on Examples, but the invention should not be limited at all by these Examples.

The structure of the double-sided adhesive tape of each of Examples 1 to 4 and Comparative Example 1 is shown in Table 1.

TABLE 1

| | | | | | | | COMPARATIVE |
|---|---|---|---|---|---|---|---|
| | | | EXAMPLE 1 | EXAMPLE 2 | EXAMPLE 3 | EXAMPLE 4 | EXAMPLE 1 |
| TAPE | ADHESIVE | MATERIAL | SBS | SBS | SBS | SBS | CR |
| STRUCTURE | LAYER FOR | LAYER | 80 | 80 | 50 | 80 | 50 |
| | POLISHING | THICKNESS (μm) | | | | | |
| | MEMBER | | | | | | |
| | SUBSTRATE | MATERIAL | PET | PET | PET | PET | PET |
| | | LAYER | 75 | 25 | 25 | 75 | 25 |
| | | THICKNESS (μm) | | | | | |
| | PRESSURE- | MATERIAL | RUBBER | RUBBER | RUBBER | ACRYLIC | RUBBER |
| | SENSITIVE | | PRESSURE- | PRESSURE- | PRESSURE- | PRESSURE- | PRESSURE- |
| | ADHESIVE | | SENSITIVE | SENSITIVE | SENSITIVE | SENSITIVE | SENSITIVE |
| | LAYER | | ADHESIVE | ADHESIVE | ADHESIVE | ADHESIVE | ADHESIVE |
| | FOR SURFACE | LAYER | 40 | 40 | 40 | 40 | 40 |
| | PLATE | THICKNESS (μm) | | | | | |
| 180°- | 50° C. PRESSURE-BONDING | | 23.0 | 21.2 | 20.0 | 22.0 | 1.5 |
| PEELING | 120° C. PRESSURE-BONDING | | 25.2 | 24.6 | 24.4 | 25.3 | 16.0 |
| PRESSURE- | | | | | | | |
| SENSITIVE | | | | | | | |
| ADHESIVE | | | | | | | |
| FORCE | | | | | | | |
| (N/20 mm) | | | | | | | |

| | | | | | | |
|---|---|---|---|---|---|---|
| WARP * POP-OFF | 50° C. PRESSURE-BONDING | NOT | NOT | NOT | NOT | NOT |
| AFTER | | OBSERVED | OBSERVED | OBSERVED | OBSERVED | OBSERVED |
| PRESSURE- | 120° C. PRESSURE-BONDING | OBSERVED | OBSERVED | OBSERVED | OBSERVED | OBSERVED |
| BONDING | | | | | | |

### Examples 1 to 3

### <Production of Thermal Adhesive Composition>

Fifty parts by mass of a styrene-butadiene-styrene block copolymer (SBS) (made by Asahi Kasei Chemicals Corporation, product name “ASAPRENE T-420”) and 50 parts by mass of SBS (made by Asahi Kasei Chemicals Corporation, product name “ASAPRENE T-432”) were added to 220 parts by mass of toluene, a solvent, and they were stirred before SBS was dissolved, for example, for approximately 30 minutes. To the obtained liquid mixture, 100 parts by mass of a tackifier (made by Arakawa Chemical Industries, Ltd., product name “ARKON M115”) and 20 parts by mass of a tackifier (made by HERCULES Inc., product name “PICOTEX #120”) were added, and they were stirred before the tackifiers were dissolved, for example, for approximately 30 minutes. ARKON M115 uses an alicycle saturated hydrocarbon resin as a major component and has a softening point of 115±5° C. and a glass transition point of 59° C. (based on the DSC measurement according to ISO-11357-2). PICOTEX #120 uses a vinyltoluene-methylstyrene copolymer as a major component and has a softening point of 118° C. and a glass transition point of 70° C.

Apart from the aforementioned work, 2 parts by mass of an antioxidant (made by OUCHI SHINKO CHEMICAL INDUSTRIAL CO., LTD., product name “NOCRAC NS-6”) and 1 part by mass of an antioxidant (made by OUCHI SHINKO CHEMICAL INDUSTRIAL CO., LTD., product name “NOCRAC MB”) were added to 8 parts by mass of isopropyl alcohol (IPA), a solvent, and they were stirred for several minutes to disperse the antioxidants in the solvent. The obtained solution of the antioxidants was added to the liquid mixture in which SBS and the tackifiers have been dissolved and they were stirred for approximately 60 minutes. Thermal adhesive composition solutions of Examples 1 to 3 were obtained by the aforementioned steps.

### <Production of Rubber Pressure-Sensitive Adhesive Composition>

After 100 parts by mass of natural rubber (Mooney viscosity 75), 30 parts by mass of SIS (made by ZEON CORPORATION, Product name “QUINTAC 3460C”, SIS having a radial structure, styrene content 25% by mass), 40 parts by mass of maleic anhydride modified C5, C9 resin (made by ZEON CORPORATION, product name “QUINTON D-200”), 40 parts by mass of phenol modified rosin (made by Sumitomo Bakelite Co., Ltd., product name “SUMILITE PR12603N”), and 1 part by mass of a phenol anti-aging agent (made by OUCHI SHINKO CHEMICAL INDUSTRIAL CO., LTD., product name “NOCRAC NS-6”) were dissolved in toluene, 3 parts by mass of isocyanate (made by NIPPON POLYURETHANE INDUSTRY CO., LTD, product name “CORONATE L”) were added thereto as a cross-linking agent, thereby allowing a rubber pressure-sensitive adhesive composition to be prepared.

### <Production of Double-Sided Adhesive Tape>

A release liner A and a release liner B each made of a polyester film having a thickness of 38 μm, one surface of each of which had been subjected to a release treatment using silicon, were provided. The width of each of the release liners A and B was 2500 mm.

In Example 1, a polyethylene terephthalate (PET) film having a thickness of 75 μm was provided as a substrate, while in Examples 2 and 3, a PET film having a thickness of 25 μm was provided as a substrate. The width of the substrate was 2500 mm.

The aforementioned thermal adhesive composition was coated on one surface of the substrate with a pressure-sensitive adhesive coater (comma coater) having a coating width of 2480 mm, and the substrate was then heated in an oven at 100° C. for 3 minutes to remove the solvents, thereby allowing a laminated body A including, as an adhesive layer for a polishing member, a thermal adhesive layer to be produced. The thermal adhesive layer had a width of 2480 mm and a thickness, after being dried, of 80 μm (Examples 1, 2) or 50 μm (Example 3).

Subsequently, the surface of the release liner A, which had been subjected to a release treatment, was turned toward the surface of the thermal adhesive layer to laminate the release liner A onto the thermal adhesive layer.

The aforementioned rubber pressure-sensitive adhesive composition was coated on one surface of the release liner B, which had been subjected to a release treatment, with a pressure-sensitive adhesive coater (comma coater) having a coating width of 2480 mm, and the release liner B was then heated in an oven at 100° C. for 3 minutes to remove the solvents, thereby allowing a laminated body B, having a width of 2480 mm and a thickness, after being dried, of 40 μm and including, as an pressure-sensitive adhesive layer for a surface plate, a rubber pressure-sensitive adhesive layer, to be produced.

Subsequently, the surface of the laminated body A, near to the substrate, was turned toward the rubber pressure-sensitive adhesive layer of the laminated body B to laminate the laminated body A onto the laminated body B, thereby allowing the double-sided adhesive tape of each of Examples 1 to 3 (release liner A/adhesive layer for polishing member (thermal adhesive layer)/substrate/pressure-sensitive adhesive layer for surface plate (rubber pressure-sensitive adhesive layer)/release liner B) to be obtained.

### Comparative Example 1

An adhesive composition whose major component was chloroprene rubber (CR) was produced as an adhesive composition for forming an adhesive layer for a polishing member.

Specifically, after 90 parts by mass of a chloroprene- methacrylic acid copolymer (made by SHOWA DENKO ELASTOMERS K.K., product name “SHOWPRENE AF”) and 10 parts by mass of a polychloropren copolymer (made by SHOWA DENKO ELASTOMERS K.K., product name “SHOWPRENE WRT”) were dissolved in toluene, the solution was mixed with 0.3 parts by mass of tetraethylenepentamine (made by Wako Pure Chemical Industries, Ltd.) that had been diluted in toluene separately. Further, 30 parts by mass of IPA, 5 parts by mass of soft water, 2 parts by mass of a phenol anti-aging agent (made by OUCHI SHINKO CHEMICAL INDUSTRIAL CO., LTD., product name “NOCRAC NS-6”), and 18 parts by mass of phenol modified rosin (made by Sumitomo Bakelite Co., Ltd., product name “SUMILITE PR12603N”) were dissolved in toluene. Further, 30 parts by mass of hydrogenated rosin material (made by Arakawa Chemical Industries, Ltd., product name “ESTER GUM HT-75”) that had been diluted in toluene separately, 0.5 parts by mass of ethylene thiourea (made by Kawaguchi Chemical Industry Co., Ltd., product name “ACCEL 22-S”), 5 parts by mass of magnesium oxide (made by Kyowa Chemical Industry Co., Ltd., product name “Kyowa Mag150”), 1 part by mass of zinc oxide, and 2 parts by mass of an alkylphenol resin (made by Arakawa Chemical Industries, Ltd., product name “TAMANOL 526”) were added to prepare a pressure-sensitive adhesive composition solution. In addition, a rubber pressure-sensitive adhesive composition, the same as those of Examples 1 to 3, was produced. Subsequently, a laminated body was produced in the same as in Examples 1 to 3, thereby allowing a double-sided adhesive tape of Comparative Example 1 to be obtained.

### Example 4

### <Production of Thermal Adhesive Composition>

Fifty parts by mass of a styrene-butadiene-styrene block copolymer (SBS) (made by Asahi Kasei Chemicals Corporation, product name “ASAPRENE T-420”) and 50 parts by mass of SBS (made by Asahi Kasei Chemicals Corporation, product name “ASAPRENE T-432”) were added to 220 parts by mass of toluene, a solvent, and they were stirred before SBS was dissolved, for example, for approximately 30 minutes. To the obtained liquid mixture, 100 parts by mass of a tackifier (made by Arakawa Chemical Industries, Ltd., product name “ARKON M115”) were added, and they were stirred before the tackifier was dissolved, for example, for approximately 30 minutes.

Apart from the aforementioned work, 2 parts by mass of an antioxidant (made by OUCHI SHINKO CHEMICAL INDUSTRIAL CO., LTD., product name “NOCRAC NS-6”) and 1 part by mass of an antioxidant (made by OUCHI SHINKO CHEMICAL INDUSTRIAL CO., LTD., product name “NOCRAC MB”) were added to 8 parts by mass of isopropyl alcohol (IPA), a solvent, and they were stirred for several minutes to disperse the antioxidants in the solvent. The obtained solution of the antioxidants was added to the liquid mixture in which SBS and the tackifier have been dissolved and they were stirred for approximately 60 minutes. A thermal adhesive composition solution of Example 4 was obtained by the aforementioned steps.

### <Production of Acrylic Pressure-Sensitive Adhesive Composition>

To 100 parts by mass of an acrylic polymer (which can be obtained by polymerizing 100 parts by mass of butyl acrylate, 5 parts by mass vinyl acetate, 3 parts by mass of an acrylic acid, and 0.1 parts by mass of acrylic acid 2-hydroxyethyl), 15 parts by mass of a terpene modified phenolic resin that is a tackifier (made by Sumitomo Bakelite Co., Ltd., product name “SUMILITE RESIN PR-12603N”), 10 parts by mass of polymerized rosin pentaerythritol ester (made by HARIMA CHEMICALS, Inc., product name “RIKATAC PCJ”), 10 parts by mass of hydrogenated rosin glycerin ester (made by HARIMA CHEMICALS, Inc., product name “RIKATAC SE10”), and 5 parts by mass of hydrogenated rosin methyl ester (made by Wuzhou Sun Shine Forestry & Chemicals Co., Ltd. of guangxi, product name “M-HDR”) were added, and then 4 parts by mass of an isocyanate cross-linking agent (made by NIPPON POLYURETHANE INDUSTRY CO., LTD., product name “CORONATE L”) and toluene were further added to make the mixture to be a uniform solution, thereby allowing an acrylic pressure-sensitive adhesive composition to be obtained.

### <Production of Double-Sided Adhesive Tape>

A release liner A and a release liner B each made of a polyester film having a thickness of 38 μm, one surface of each of which had been subjected to a release treatment using silicon, were provided. The width of each of the release liners A and B was 2500 mm.

In addition, a polyethylene terephthalate (PET) film having a thickness of 75 μm was provided as a substrate. The width of the substrate was 2500 mm.

The aforementioned thermal adhesive composition was coated on one surface of the substrate with a pressure-sensitive adhesive coater (comma coater) having a coating width of 2480 mm, and the substrate was then heated in an oven at 100° C. for 3 minutes to remove the solvents, thereby allowing a laminated body A including, as an adhesive layer for a polishing member, a thermal adhesive layer to be produced. The thermal adhesive layer had a width of 2480 mm and a thickness, after being dried, of 80 μm.

Subsequently, the surface of the release liner A, which had been subjected to a release treatment, was turned toward the surface of the thermal adhesive layer to laminate the release liner A onto the thermal adhesive layer.

The aforementioned acrylic pressure-sensitive adhesive composition was coated on one surface of the release liner B, which had been subjected to a release treatment, with a pressure-sensitive adhesive coater (comma coater) having a coating width of 2480 mm, and the release liner B was then heated in an oven at 100° C. for 3 minutes to remove the solvents, thereby allowing a laminated body B, having a width of 2480 mm and a thickness, after being dried, of 40 μm and including, as an pressure-sensitive adhesive layer for a surface plate, an acrylic pressure-sensitive adhesive layer, to be produced.

Subsequently, the surface of the laminated body A, near to the substrate, was turned toward the acrylic pressure-sensitive adhesive layer of the laminated body B to laminate the laminated body A onto the laminated body B, thereby allowing the double-sided adhesive tape of Example 4 (release liner A/adhesive layer for polishing member (thermal adhesive layer)/substrate/pressure-sensitive adhesive layer for surface plate (acrylic pressure-sensitive adhesive layer)/release liner B) to be obtained.

(Determination of Warp and Pop-Off after Pressure-Bonding and Test for 180°-Peeling Pressure-Sensitive Adhesive Force)

The double-sided adhesive tape of each of Examples 1 to 4 and Comparative Example 1 was backed up by peeling off the release liner B near to the pressure-sensitive adhesive layer for a surface plate and by attaching a PET film having a thickness of 50 μm. A specimen was produced by cutting the backed-up double-sided adhesive tape into apiece having a rectangular shape of 20 mm in width×100 mm in length. From the double-sided adhesive tape of each of Examples 1 to 4 and Comparative Example 1, a specimen α for the later-described 50° C. pressure-bonding and a specimen β for the 120° C. pressure-bonding were provided. After the release liner A in each specimen was peeled off, the adhesive layer for a polishing member was brought into contact with a PET film having a thickness of 50 μm, which served as an adherend, so that: in the case of the specimen α of each of Examples and Comparative Example, both were pressure-bonded together with a pressure of 5.19 kgf and at 50° C. for 30 seconds; and in the case of the specimen β of each of Examples and Comparative Example, both were pressure-bonded together with a pressure of 5.19 kgf and at 120° C. for 30 seconds. These specimens were left uncontrolled under an environment of temperature of 23° C. and relative humidity (RH) of 50% for 30 minutes.

A 180°-peeling pressure-sensitive adhesive force (unit: N/20 mm) to the adherend PET film (PET plate) was measured: by using a tensile tester (“Autograph” made by Shimadzu Corporation); under an environment of 23° C.×RH 50% in accordance with JIS Z 0237 (2005); and under the conditions in which a peeling angle was 180° and tensile speed was 50 mm/min. The results are shown in Table 1.

As shown in Table 1, when being pressure-bonded at 120° C., the double-sided adhesive tape of each of Examples and Comparative Example exhibited a large pressure-sensitive adhesive force of 15 N/20 mm or more. In particular, the tape of each of Examples exhibited a larger pressure-sensitive adhesive force of 20 N/20 mm or more. On the other hand, when being pressure-bonded at 50° C., the tape of each of Examples exhibited a large pressure-sensitive adhesive force of 15 N/20 mm or more, and further 20 N/20 mm or more, while the tape of Comparative Example 1 exhibited an extremely small pressure-sensitive adhesive force of 1.5 N/20 mm. From these results, it has been confirmed that, according to a double-sided adhesive tape of the present embodiment, large adhesive strength can be obtained even in thermal adhesion at a low temperature.

After each specimen, from which a release liner had not been peeled off, was thermally bonded under the same conditions as those described above, and was naturally cooled at room temperature for 30 minutes or longer, presence or absence of a warp of the tape and pop-off of the release liner were visually observed. The results are shown in Table 1.

As shown in Table 1, when being pressure-bonded at 50° C., a warp and pop-off were not observed after the pressure-bonding; however, when being pressure-bonded at 120° C., a warp and pop-off were observed in each of the specimens. From these results, it has been confirmed that a double-sided adhesive tape according to the present embodiment does not cause a warp and pop-off even in pressure-bonding at a low temperature and has a large pressure-sensitive adhesive force.

### (Tackiness Evaluation)

The double-sided adhesive tape of each of Examples 1 to 4 was backed up by peeling off the release liner B near to the pressure-sensitive adhesive layer for a surface plate and by attaching a PET film having thickness of 50 μm. A specimen was produced by cutting the backed-up double-sided adhesive tape into a piece having a rectangular shape of 20 mm in width×100 mm in length. After the release liner A in each specimen was peeled off, the adhesive layer for a polishing member was brought into contact with non-woven cloth (made by AMBIC CO., LTD., product name “HimelonSP30B”), which served as an adherend, and both were pressure-bonded together with a 0.5 kg-roller under an environment of a temperature of 23° C.

Immediately after the pressure-bonding, a 180°-peeling pressure-sensitive adhesive force (unit: N/20 mm) to the adherend was measured: by using a tensile tester (“Autograph” made by Shimadzu Corporation); under an environment of 23° C.×RH 50% in accordance with JIS Z 0237 (2005); and under the conditions in which a peeling angle was 180° and tensile speed was 50 mm/min, thereby allowing the tackiness of the double-sided adhesive tape to be evaluated. Also, measurements were similarly performed under the conditions in which the roller used in the pressure-bonding was changed to 2 kg and 5 kg, respectively.

Further, the tackiness (180°-peeling pressure-sensitive adhesive force (unit: N/20 mm) to an adherend) of each sample, occurring when being pressure-bonded with a 0.5 kg-roller, 2 kg-roller, or 5 kg-roller, was measured by a way similar to that described above, except that the non-woven cloth that served as an adherend was changed to non-woven cloth (made by AMBIC CO., LTD., product name “Himelon N9795B”), thereby allowing the tackiness thereof to be evaluated. The results are shown in Table 2.

TABLE 2

| NON-WOVEN | ROLLER | TACKINESS (N/20 mm) | |
|---|---|---|---|
| CLOTH | WEIGHT (kg) | EXAMPLE 1 | EXAMPLE 4 |
| HIMELON SP30B | 0.5 | 0 | 0.2 |
| | 2 | 0 | 0.35 |
| | 5 | 0.1 | 1.5 |
| HIMELON N9795B | 0.5 | 0.1 | 0.1 |
| | 2 | 0.1 | 0.7 |
| | 5 | 0.3 | 0.7 |

It has been confirmed that, as shown in Table 2, in the double-sided adhesive tape of Example 4, not containing a tackifier (made by HERCULES Inc., product name “PICOTEX #120”), a tackiness, i.e., an adhesive force occurring immediately after being pressure-bonded to an adherend is more improved in comparison with the double-sided adhesive tape of Example 1 containing the tackifier. With an improved tackiness, it can be suppressed that pop-off or slippage of a double-sided adhesive tape may occur when being handled during when the tape is tentatively pressure-bonded to a polishing member to when the tape is firmly pressure-bonded.

### (Chemical Resistance Test)

Multiple laminated bodies, each of which is produced by using the double-sided adhesive tape of the aforementioned Example 2 and is composed of an adherend PET film, the double-sided adhesive tape, and a backed-up PET film, were provided. Some of the laminated bodies were dipped in a nitric acid aqueous solution (HNO₃ aqueous solution) of pH 2, and the rest thereof were dipped in a sodium hydroxide aqueous solution (NaOH aqueous solution) of pH 12. After they were dipped at room temperature (23° C.) for 24 hours, one of the specimens in the HNO₃ aqueous solution and one of the specimens in the NaOH aqueous solution were taken out, and they were cleaned and moisture attached thereto was wiped off. Thereafter, a 180°-peeling pressure-sensitive adhesive force of the adhesive layer for a polishing member to the adherend PET film, and a 180°-peeling pressure-sensitive adhesive force of the pressure-sensitive adhesive layer for a surface plate to the back-up PET film, were measured in the same way as that described above. Further, a 180°-peeling pressure-sensitive adhesive force of each of specimens, which had been dipped for 48 hours and 72 hours, respectively, was also measured in the same way. Further, a 180°-peeling pressure-sensitive adhesive force of a specimen, which had been dipped for 0 hour, i.e., which had not been dipped in the aqueous solutions, was also measured in the same way. The results are shown in Table 3.

TABLE 3

| | | 180° PEELING PRESSURE-SENSITIVE | | | |
|---|---|---|---|---|---|
| | | ADHESIVE FORCE (N/20 mm) | | | |
| | | | | PRESSURE-SENSITIVE | |
| | | ADHESIVE | | ADHESIVE | |
| | | LAYER FOR | | LAYER FOR | |
| | | POLISHING MEMBER | | SURFACE PLATE | |
| | | HNO₃ | NaOH | HNO₃ | NaOH |
| | | AQUEOUS | AQUEOUS | AQUEOUS | AQUEOUS |
| | | SOLUTION | SOLUTION | SOLUTION | SOLUTION |
| DIPPING | 0 | 26 | | 9 | |
| PERIOD | 24 | 27 | 27 | 10 | 10 |
| OF | 48 | 25 | 27 | 10 | 10 |
| TIME (h) | 72 | 27 | 28 | 11 | 11 |

As shown in Table 3, in the thermal adhesive layer that is a adhesive layer for a polishing member and in the rubber pressure-sensitive adhesive layer that is a pressure-sensitive adhesive layer for a surface plate, there were almost no changes between the pressure-sensitive adhesive force of the specimen dipped for each of 24 hours, 48 hours, and 72 hours, and that of the specimen dipped for 0 hour, in both the cases of the HNO₃ aqueous solution and the NaOH aqueous solution. From these results, it has been confirmed that a double-sided adhesive tape according to the present embodiment has a high chemical resistance.

Hereinafter, the embodiment described above will be summarized.

### (Item 1)

A double-sided adhesive tape for fixing a polishing member, comprising: a substrate; a thermal adhesive layer that is provided on one surface of the substrate and is formed of a thermal adhesive containing 40 to 100% by mass of a thermoplastic elastomer based on the total mass of the thermal adhesive; and a pressure-sensitive adhesive layer provided on the other surface of the substrate, in which, when being pressure-bonded to a polyethylene terephthalate film with a pressure of 5.19 kgf and at 50° C. for 30 seconds, the thermal adhesive layer has a 180°-peeling pressure-sensitive adhesive force to the polyethylene terephthalate film of 15 N/20 mm or more at a tensile speed of 50 mm/min.

### (Item 2)

The double-sided adhesive tape according to Item 1, in which the pressure-sensitive adhesive layer contains one or more pressure-sensitive adhesives selected from the group consisting of a rubber pressure-sensitive adhesive and an acrylic pressure-sensitive adhesive.

### (Item 3)

The double-sided adhesive tape according to Item 1 or Item 2, in which the melting temperature of the thermal adhesive layer is 50 to 110° C.

### (Item 4)

The double-sided adhesive tape according to any one of Items 1 to 3, in which the thermal adhesive layer contains a styrene-butadiene elastomer.

### (Item 5)

The double-sided adhesive tape according to any one of Items 1 to 4, in which the thermal adhesive layer contains a tackifier.

### (Item 6)

The double-sided adhesive tape according to any one of Items 1 to 3, in which the thermal adhesive layer contains a styrene-butadiene elastomer and a tackifier, and in which the content of the tackifier is 50 to 150 parts by mass based on 100 parts by mass of the styrene-butadiene elastomer.

### (Item 7)

The double-sided adhesive tape according to Item 5 or Item 6, in which the glass transition point of the tackifier is 60° C. or lower.

What is claimed is:

1. A double-sided adhesive tape for fixing a polishing member, comprising:
a substrate;
a thermal adhesive layer that is provided on one surface of the substrate and is formed of a thermal adhesive containing 40 to 100% by mass of a thermoplastic elastomer based on the total mass of the thermal adhesive; and
a pressure-sensitive adhesive layer provided on the other surface of the substrate, wherein
when being pressure-bonded to a polyethylene terephthalate film with a pressure of 5.19 kgf and at 50° C. for 30 seconds, the thermal adhesive layer has a 180°-peeling pressure-sensitive adhesive force to the polyethylene terephthalate film of 15 N/20 mm or more at a tensile speed of 50 mm/min.

2. The double-sided adhesive tape according to claim 1, wherein
the pressure-sensitive adhesive layer contains one or more pressure-sensitive adhesives selected from the group consisting of a rubber pressure-sensitive adhesive and an acrylic pressure-sensitive adhesive.

3. The double-sided adhesive tape according to claim 1, wherein
the melting temperature of the thermal adhesive layer is 50 to 110° C.

4. The double-sided adhesive tape according to claim 1, wherein
the thermal adhesive layer contains a styrene-butadiene elastomer.

5. The double-sided adhesive tape according to claim 1, wherein
the thermal adhesive layer contains a tackifier.

6. The double-sided adhesive tape according to claim 1, wherein
the thermal adhesive layer contains a styrene-butadiene elastomer and a tackifier, and wherein
the content of the tackifier is 50 to 150 parts by mass based on 100 parts by mass of the styrene-butadiene elastomer.

7. The double-sided adhesive tape according to claim 5, wherein
the glass transition point of the tackifier is 60° C. or lower.

8. The double-sided adhesive tape according to claim 2, wherein
the melting temperature of the thermal adhesive layer is 50 to 110° C.

9. The double-sided adhesive tape according to claim 2, wherein
the thermal adhesive layer contains a styrene-butadiene elastomer.

10. The double-sided adhesive tape according to claim 3, wherein
the thermal adhesive layer contains a styrene-butadiene elastomer.

11. The double-sided adhesive tape according to claim 8, wherein
the thermal adhesive layer contains a styrene-butadiene elastomer.

12. The double-sided adhesive tape according to claim 2, wherein
the thermal adhesive layer contains a tackifier.

13. The double-sided adhesive tape according to claim 3, wherein
the thermal adhesive layer contains a tackifier.

14. The double-sided adhesive tape according to claim 4, wherein
the thermal adhesive layer contains a tackifier.

15. The double-sided adhesive tape according to claim 8, wherein
the thermal adhesive layer contains a tackifier.

16. The double-sided adhesive tape according to claim 9, wherein
the thermal adhesive layer contains a tackifier.

17. The double-sided adhesive tape according to claim 10, wherein
the thermal adhesive layer contains a tackifier.

18. The double-sided adhesive tape according to claim 11, wherein
the thermal adhesive layer contains a tackifier.

19. The double-sided adhesive tape according to claim 2, wherein
the thermal adhesive layer contains a styrene-butadiene elastomer and a tackifier, and wherein
the content of the tackifier is 50 to 150 parts by mass based on 100 parts by mass of the styrene-butadiene elastomer.

20. The double-sided adhesive tape according to claim 3, wherein
the thermal adhesive layer contains a styrene-butadiene elastomer and a tackifier, and wherein
the content of the tackifier is 50 to 150 parts by mass based on 100 parts by mass of the styrene-butadiene elastomer.
